(19) United States
(12) Patent Application Publication
(10) Pub. No.: US 2022/0107858 A1
(43) Pub. Date: Apr. 7, 2022

(54) METHODS AND SYSTEMS FOR MULTI-RESOURCE OUTAGE DETECTION FOR A SYSTEM OF NETWORKED COMPUTING DEVICES AND ROOT CAUSE IDENTIFICATION

(71) Applicant: Microsoft Technology Licensing, LLC, Redmond, WA (US)

(72) Inventors: Navendu Jain, Snohomish, WA (US); Phuong Ngoc Viet Pham, Redmond, WA (US); Shane Hu, Seattle, WA (US)

(21) Appl. No.: 17/060,835

(22) Filed: Oct. 1, 2020

(51) Int. Cl. G06F 11/07; G06N 20/00

(52) U.S. Cl. CPC G06F 11/079; G06N 20/00; G06F 11/0751; G06F 11/0709

(57) ABSTRACT

Methods, systems, apparatuses, and computer-readable storage mediums are described for detecting a common root cause for a multi-resource outage in a computing environment. For example, incident reports associated with multiple resources and that are generated by a plurality of monitors are featurized and provided to a classification model. The classification model detects whether a multi-resource outage exists based on the featurized incident reports and identifies a subset of the incident reports upon which the detection is based. Upon detecting a multi-resource outage, an analysis is performed to determine a potential common root cause of the multi-resource outage.

### BACKGROUND

Cloud services are services (e.g., applications and/or other computer system resources) hosted in the “cloud” (e.g., on servers available over the Internet) that are available to users of computing devices on demand, without direct active management by the users. For example, cloud services may be hosted in data centers or elsewhere, and may be accessed by desktop computers, laptops, smart phones, and other types of computing devices.

In running cloud services, monitoring systems can create a high volume of issues or incidents which need to be handled by corresponding agents, such as on-call engineers. For instance, in an information technology (IT) setting, engineers may receive reports corresponding to various issues relating the performance, availability, throughput, security and/or health of the cloud-based services. Each issue generally relates to a specific service or customer (e.g., a tenant). When debugging the incident, engineers can spend any number of hours debugging the service or resource. However, in certain situations, the problem is related to a common dependency service (e.g., DNS) or an underlying hosting infrastructure (e.g., power, temperature issues) that affects multiple resource and tenants. Determining that such a problem exists is often difficult, as the incident reports are localized to a particular resource or tenant.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Methods, systems, apparatuses, and computer-readable storage mediums are described for detecting a common root cause for a multi-resource outage in a computing environment. For example, incident reports associated with multiple resources (e.g., services) and that are generated by a plurality of monitors may be featurized and provided to a classification model. The classification model detects whether a multi-resource outage exists based on the featurized incident reports and identifies a subset of the incident reports upon which the detection is based. Upon detecting a multi-resource outage, an analysis is performed to determine a potential common root cause of the multi-resource outage. The analysis is performed with respect to a dependency graph comprising a plurality of nodes, each representative of a different incident type. During the analysis, each incident report of the identified subset is mapped to a node based on an incident type specified by the incident report. A parent node that is common to each of such nodes is identified. The incident type associated directly or indirectly with the parent node is identified as being the common root cause of the multi-resource outage.

Further features and advantages of embodiments, as well as the structure and operation of various embodiments, are described in detail below with reference to the accompanying drawings. It is noted that the methods and systems are not limited to the specific embodiments described herein. Such embodiments are presented herein for illustrative purposes only. Additional embodiments will be apparent to persons skilled in the relevant art(s) based on the teachings contained herein.

### BRIEF DESCRIPTION OF THE DRAWINGS/FIGURES

The accompanying drawings, which are incorporated herein and form a part of the specification, illustrate embodiments of the present application and, together with the description, further serve to explain the principles of the embodiments and to enable a person skilled in the pertinent art to make and use the embodiments.

FIG. 1 shows a block diagram of a system for detecting a multi-resource outage in accordance with an example embodiment.

FIG. 2 is a block diagram of a system for detecting a multi-resource outage in accordance with another example embodiment.

FIG. 3 depicts a listing of incident reports in accordance with an example embodiment.

FIG. 4 depicts a dependency graph in accordance with an example embodiment.

FIG. 5 shows a flowchart 500 of a computer-implemented method for detecting and remediating a multi-resource outage with respect to a plurality of resources implemented on a system of networked computing devices in accordance with example embodiment.

FIG. 6 shows a flowchart of a computer-implemented method for generating a machine learning model in accordance with example embodiment.

FIG. 7 shows a flowchart of a computer-implemented method for determining a set of monitors from which first incident reports are to be utilized for providing features to a machine learning algorithm in accordance with example embodiment.

FIG. 8 is a block diagram of an example processor-based computer system that may be used to implement various embodiments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments, but also encompasses combinations of the disclosed embodiments, as well as modifications to the disclosed embodiments.

References in the specification to “one embodiment,” “an embodiment,” “an example embodiment,” etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Embodiments

Embodiments described herein are directed to detecting a multi-resource outage and/or a common root cause for the multi-resource outage in a computing environment. For example, incident reports associated with multiple resources (e.g., services) and that are generated by a plurality of monitors may be featurized and provided to a classification model. The classification model detects whether a multi-resource outage exists based on the featurized incident reports and identifies a subset of the incident reports upon which the detection is based. Upon detecting a multi-resource outage, an analysis is performed to determine a common root cause of the multi-resource outage. The analysis is performed with respect to a dependency graph comprising a plurality of nodes, each representative of a different incident type. During the analysis, each incident report of the identified subset is mapped to a node based on an incident type specified by the incident report. A parent node that is common to each of such nodes is identified. The incident type associated with the parent node is identified as being the common root cause of the multi-resource outage.

The foregoing techniques advantageously reduce the time to detect an underlying infrastructure-related issue that is causing issues with multiple resources and/or affecting multiple tenants. Accordingly, the downtime experienced by multiple customers with respect to affected resources or services is dramatically reduced. Moreover, the machine learning algorithm utilized to generate the classification model is trained using a selected set of monitors. This selected set of monitors are determined to issue incident reports that are highly correlated with past, known multi-resource outages. Not only does this limit the data to be utilized when training the machine learning algorithm, it improves the accuracy of the resulting classification model. Accordingly, the techniques described herein also improve the functioning of a computing device during the training of the machine learning algorithm by reducing the number of compute resources (e.g., input/output (I/O) operations, processor cycles, power, memory, etc.) that are utilized during training.

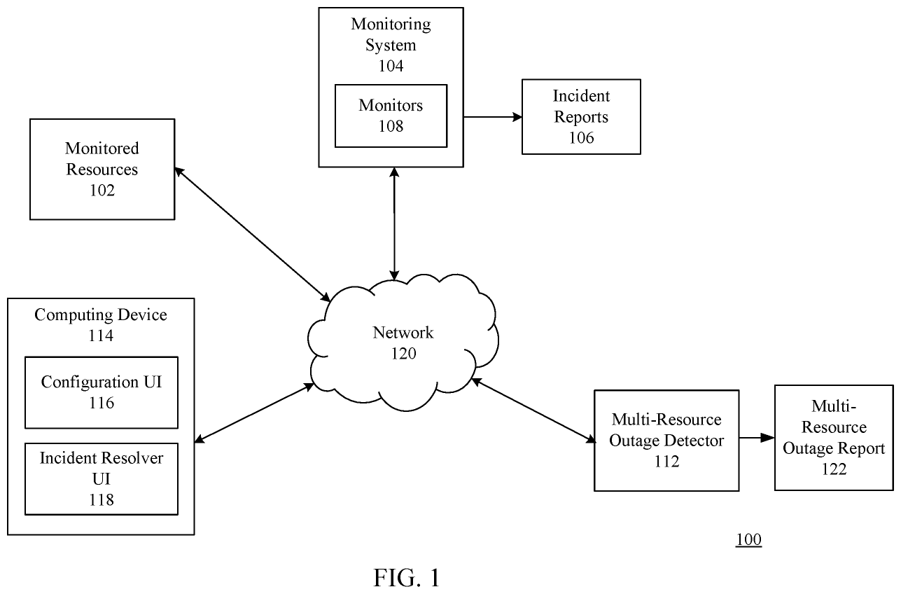

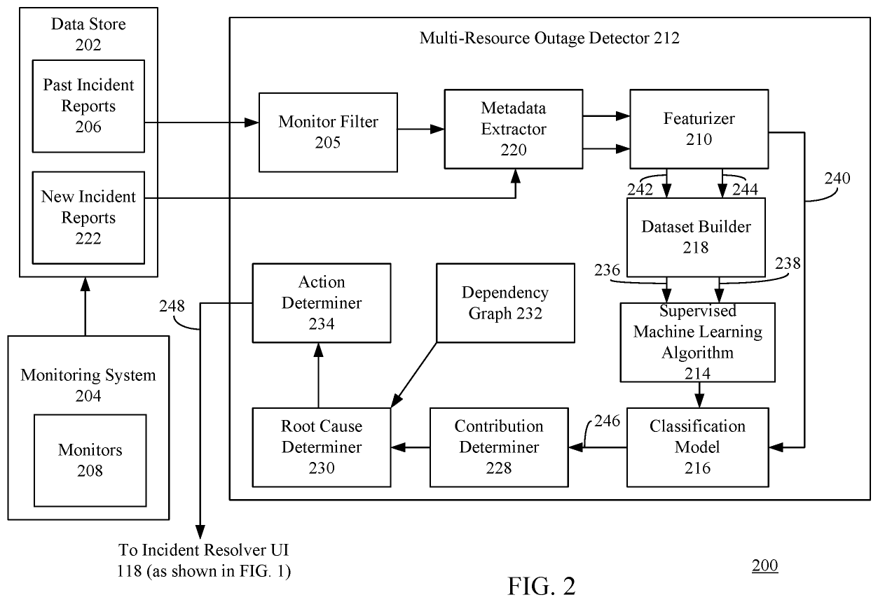

Example embodiments will now be described that are directed to techniques for detecting multi-resource outages. For instance, FIG. 1 shows a block diagram of a system 100 comprising a set of monitored resources 102, a monitoring system 104, a multi-resource outage detector 112, and a computing device 114, each of which may be coupled via one or more networks 120. As illustrated in FIG. 1, monitoring system 104 may generate incident reports 106. Computing device 114 includes a configuration user interface (UI) and an incident resolver UI 118.

Network 120 may comprise one or more networks such as local area networks (LANs), wide area networks (WANs), enterprise networks, the Internet, etc., and may include one or more of wired and/or wireless portions. Monitored resources 102, monitoring system 104, multi-resource outage detector 112, and computing device 114 may communicate with each other via network 120 through a respective network interface. In an embodiment, monitored resources 102, monitoring system 104, multi-resource outage detector 112, and computing device 114 may communicate via one or more application programming interfaces (API). Each of these components will now be described in more detail.

Monitored resources 102 include any one or more resources that may be monitored for performance and/or health reasons. In examples, monitored resources 102 include applications or services that may be executing on a local computing device, on a server or collection of servers (located in one or more datacenters), on the cloud (e.g., as a web application or web-based service), or executing elsewhere. For instance, monitored resources 102 may include one or more nodes (or servers) of a cloud-based environment, virtual machines, databases, software services, customer-impacting or customer-facing resources, or any other resource. As described in greater detail below, monitored resources 102 may be monitored for various performance or health parameters that may indicate whether the resources are performing as intended, or if issues may be present (e.g., excessive processor usage, storage-related issues, excessive temperatures, power-related issues, etc.) that may potentially hinder performance of those resources. Each of resources 102 may be utilized by one or more customers (or tenants). For example, a first set of resources 102 may be utilized by a first tenant, a second set of resources 102 may be utilized by a second tenant, and a third subset of resources 102 may be utilized by a plurality of tenants.

Monitoring system 104 may include one or more monitors 108 for monitoring the performance and/or health of monitored resources 102. Examples of monitors 108 include, but are not limited to, computing devices, servers, sensor devices, etc. and/or monitoring algorithms configured for execution on such devices. Monitors 108 may be configured for monitoring processor usage or load, processor temperatures, response times (e.g., network response times), memory and/or storage usage, facility parameters (e.g., sensors present in a server room), power levels, or any other parameter that may be used to measure the performance or health of a resource. In examples, monitoring system 104 may continuously obtain from monitored resources 102 one or more real-time (or near real-time) signals for each of the monitored resources for measuring the resource's performance. In other examples, monitoring system 104 may obtain such signals at predetermined intervals or time(s) of day.

Monitors 108 may generate incident reports 106 based on signals received from monitored resources 102. In implementations, monitors may identify certain criteria that defines how or when an incident report should be generated based on the received signals. For instance, each of monitors 208 may comprise a function that obtains the signals indicative of the performance or health of a resource, performance aggregation or other computations or mathematical operations on the signals (e.g., averaging), and compares the result with a predefined threshold. As an illustration, a monitor may be configured to determine whether a central processing unit (CPU) usage averaged over a certain time period exceeds a threshold usage value, and if the threshold is exceeded, an incident report describing such an event may be generated. In another example, a monitor may be configured to determine whether a virtual machine is properly executing and generate an incident report describing such an event responsive to determining that the virtual machine is not properly executing. In a further example, a monitor may be configured to determine whether data is accessible via a storage account and generate an incident report describing such an event responsive to determining that the data is not accessible. These examples are only illustrative, and monitors may be implemented to generate alerts for any performance or health parameter of monitored resources 102.

In one particular example, monitored resources 102 may include thousands of servers and thousands of user computers (e.g., desktops and laptops) connected to a network (e.g., network 120). The servers may each be a certain type of server such as a load balancing server, a firewall server, a database server, an authentication server, a personnel management server, a web server, a file system server, and so on. In addition, the user computers may each be a certain type such as a management computer, a technical support computer, a developer computer, a secretarial computer, and so on. Each server and user computer may have various applications and/or services installed that are needed to support the function of the computer. Monitoring system 104 may be configured to monitor the performance and/or health of each of such resources, and generate incident reports 106 where a monitor identifies potentially abnormal activity (e.g., predefined threshold values have been exceeded for a given monitor).

Incident reports 106, for instance, may be indicative of any type of incident, including but not limited to, incidents generated as a result of monitoring monitored resources 102. Examples of incident types include, but are not limited, to virtual machine-related incidents (e.g., related to the health and/or inaccessibility of a virtual machine), storage-related incidents (e.g., related to the health and/or inaccessibility of storage devices and/or storage accounts for accessing such devices), network-related incidents (e.g., related to the performance and/or inaccessibility of a network), power-related issues (e.g., related to power levels (or lack thereof) of computing devices and/or facilities being monitored), temperature-related issues (e.g., related to temperature levels of computing devices and/or facilities being monitored), etc. Incident reports 106 may identify contextual information associated with an underlying issue with respect to one or more monitored resources 102. For instance, incident reports 106 may include one or more reports that identify alerts or events generated in a computing environment (e.g., a datacenter), where the alerts or events may indicate symptoms of a problem with any of monitored resources 102 (e.g., a service, application, etc.). As an illustrative example, an incident report may identify the computing environment (e.g., a datacenter from a plurality of different datacenters) in which the affected resources is located, specify the incident type, identify monitored resources 102 affected by the incident, a timestamp that indicates a time at which the incident occurred and/or when the report was generated, a description of the incident (e.g., that a monitored resource is exceeding a threshold processor usage, storage usage, memory usage, a threshold temperature, that a network ping exceeded a predetermined threshold, etc.). In another example, incident reports 106 may also indicate a temperature of a physical location of devices, such as a server room or a building that houses a datacenter. However, these are examples only and are not intended to be limiting, and persons skilled in the relevant art(s) will appreciate that an incident as used herein may comprise any event occurring on or in relation to a computing device, system or network.

When incident reports 106 are generated, monitoring system 104 may provide incident reports 106 to multi-resource outage detector 112. Multi-resource outage detector 112 is configured to analyze incident reports 106 and determine whether incidents (e.g., outages) associated with multiple resources of monitored resources 102 are due to the same underlying (or common) root cause. Upon determining that a multi-resource outage exists, multi-resource outage detector 112 may identify the root cause of the multi-service outage. Examples of root causes include, but are not limited to, a power loss, a network disruption, a domain name system (DNS) failure, a temperature-related issue, etc. Multi-resource outage detector 112 may identify the root cause of a multi-resource outage based on analysis of a dependency graph of resource dependencies. Additional details regarding multi-resource outage detector 112 are described below with reference to FIG. 2.

Upon identifying the root cause, multi-resource outage detector 112 may generate and provide a multi-resource outage report 122 to one or more users (e.g., an engineer or team or automation) for resolution of the multi-resource outage. The report may include contextual data or metadata associated with the multi-resource outage, such as details relating to when the multi-resource outage occurred, the computing environment in which the multi-resource outage occurred, the location (e.g., geographical location, building, etc.) of the multi-resource outage, all the incidents reports of incident reports 106 related to the multi-resource outage, what monitors detected potentially abnormal activity, the resources of monitored resources 102 impacted by the multi-resource outage, and/or any other data (e.g., time series analysis of incident reports) which may be useful in determining an appropriate action to resolve the multi-resource outage. The report may be provided in any suitable manner, such as in incident resolver UI 118 that may be accessed by user(s) for viewing details relating to the multi-resource outage.

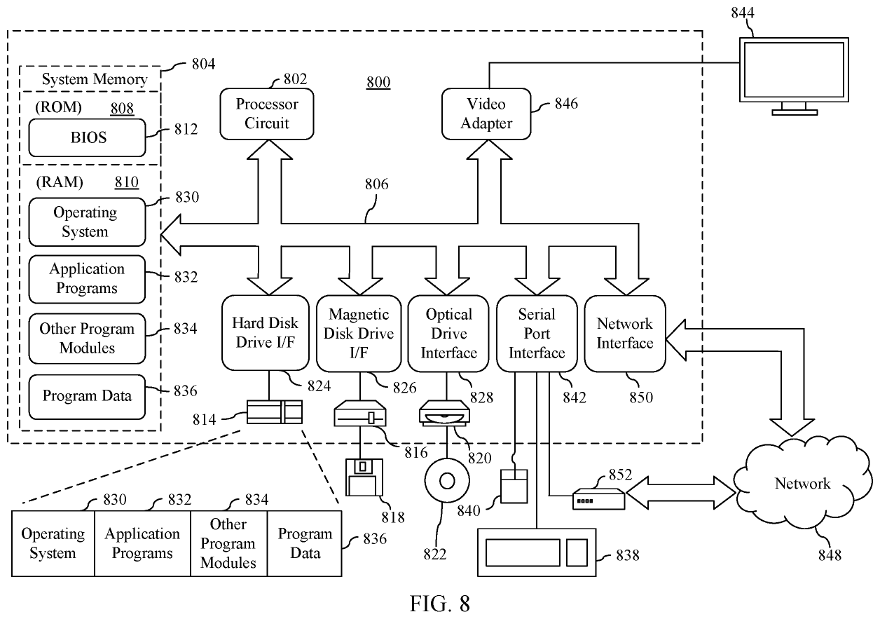

Computing device 114 may manage generated incident reports 106 and/or multi-service outage reports with respect to network(s) 120 or monitored resources 102. Computing device 114 may represent a processor-based electronic device capable of executing computer programs installed thereon. In one embodiment, computing device 114 comprises a mobile device, such as a mobile phone (e.g., a smart phone), a laptop computer, a tablet computer, a netbook, a wearable computer, or any other mobile device capable of executing computing programs. In another embodiment, computing device 114 comprises a desktop computer, server, or other non-mobile computing platform that is capable of executing computing programs. An example computing device that may incorporate the functionality of computing device 114 will be discussed below in reference to FIG. 8. Although computing device 114 is shown as a standalone computing device, in an embodiment, computing device 114 may be included as a node(s) in one or more other computing devices (not shown), or as a virtual machine.

Configuration UI 116 may comprise an interface through which one or more configuration settings of monitoring system 104 may be inputted, reviewed, and/or accepted for implementation. For instance, configuration UI 116 may present one or more dashboards (e.g., reporting or analytics dashboards) or other interfaces for viewing performance and/or health information of monitored resources 102. In some further implementations, such dashboards or interfaces may also provide an insight associated with a change in incident volume if a recommended configuration change is implemented, such as an expected volume change (e.g., an estimated volume reduction expressed as a percent). These examples are not intended to be limiting, however, as configuration UI 116 may comprise any UI (such as an administrative console) or configuring aspects of monitoring system 104, or any other system discussed herein.

Incident resolver UI 118 provides an interface for a user to view, manage, and/or respond to incident reports 106 and/or multi-resource outage reports (e.g., multi-service outage report 122). Incident resolver UI 118 may also be configured to provide any contextual data associated with each multi-service outage (e.g., via multi-service outage report 122), such as details relating to when the multi-resource outage occurred, the computing environment in which the multi-resource outage occurred, all the incident reports of incident reports 106 related to the multi-resource outage, what monitors detected potentially abnormal activity related to the multi-resource outage, or any other data which may be useful in determining an appropriate action to resolve the multi-resource outage, etc. In implementations, incident resolver UI 118 may present an interface through which a user can select any type of resolution action for an incident. Such resolution actions may be inputted manually, may be generated as recommended actions and provided on incident resolver UI 118 for selection, or identified in any other manner. In some implementations, incident resolver UI 118 generates notifications when a new multi-resource outage arises, and may present such notification on a user interface or cause the notification to be transmitted (e.g., via e-mail, text message, or other messaging service) to an engineer or team responsible for addressing the incident.

It is noted and understood that implementations are not limited to the illustrative arrangement shown in FIG. 1. Rather, system 100 comprise any number of computing devices and/or servers coupled in any manner. For instance, though monitored resources 102, monitoring system 104, multi-resource outage detector 112, and computing device 114 are illustrated as separate from each other, any one or more of such components (or subcomponents) may be co-located, located remote from each other, may be implemented on a single computing device or server, or may be implemented on or distributed across one or more additional computing devices not expressly illustrated in FIG. 1.

FIG. 2 is a block diagram of a system for detecting a multi-resource outage in accordance with an embodiment. As shown in FIG. 2, system 200 comprises a data store 202, a monitoring system 204, and a multi-resource outage detector 212. Monitoring system 204 and multi-resource outage detector 212 are examples of monitoring system 104 and multi-resource outage detector 112, as respectively described above with reference to FIG. 1. Data store 202 includes past incident reports 204 (i.e., incident reports that were generated over the course of several weeks, months, or years) relating to past incidents in a computing environment being monitored. Incident reports 206 are examples of incident reports 106, as described above with reference to FIG. 1. Incident reports 206 are generated by monitoring system 204. In accordance with an embodiment, data store 202 comprises a Microsoft® Azure® Data Explorer (or Kusto) cluster, published by Microsoft® Corporation of Redmond, Wash.

Monitoring system 204 comprises a plurality of monitors 208, which are examples of monitors 108, as described above with reference to FIG. 1. Each of monitors 208 may be configured to monitor the performance and/or health of resources (e.g., resources 102, as shown in FIG. 1). For instance, each of monitors 208 may monitor processor usage or load, processor temperatures, response times (e.g., network response times), memory and/or storage usage, facility parameters (e.g., sensors present in a server room), or any other parameter that may be used to measure the performance or health of a resource. Monitors 280 may continuously obtain from the resources one or more real-time (or near real-time) signals for each of the monitored resources for measuring the resource's performance. In other examples, monitors 208 may obtain such signals at predetermined intervals or time(s) of day.

Multi-resource outage detector 212 comprises a monitor filter 205, a metadata extractor 220, a featurizer 210, a dataset builder 218, a supervised machine learning algorithm 214, classification model 216, a contribution determiner 228, a root cause determiner 230, a dependency graph 232, and an action determiner 234. Monitor filter 205 is configured to determine a set of monitors from which past incident reports 206 is to be collected. The collected past incident reports 206 are utilized to train supervised machine learning algorithm 214 to generate classification model 216. Monitor filter 205 is configured to generate a monitor score for each of monitors 208. The monitor score for a particular monitor is indicative of a level of correlation between incident reports issued by that monitor and past multi-resource outages. Monitors of monitors 208 having a relatively higher level of correlation with past multi-resource outages (e.g., monitors 208 that generate incident reports during past, known multi-resource outages) are utilized for past incident reports 206 collection. For instance, it has been observed that certain monitors of monitors 208 generate more alerts than other monitors. Monitors in the same computing environment that generate more incident reports during a time period associated with multi-resource outages (e.g., monitors that generate incident reports close in time during determined multi-resource outages) than compared to time periods in which no multi-resource outages occur may be more indicative of multi-resource outages. Accordingly, such monitors may have a higher monitor score. It has been further observed that certain monitors are dynamic in that their behavior periodically changes. For instance, the frequency at which incident reports are generated by a monitor may change, e.g., due to changes in the computing environment being monitored or changes to the configuration settings of the monitor. Accordingly, such changes in frequency may also be used as a factor to generate a monitor score for a particular monitor.

In accordance with an embodiment, the monitor score for a particular monitor is generated in accordance with Equation 1, which is shown below:

$$Monitor Score = {Σ}_{Periods} {w}_{j} {Σ}_{monitors} \frac{{n}_{{monitor}_{i}}}{{Frequency}_{{monitor}_{i}}} \qquad ( Equation 1 )$$

In accordance with Equation 1, the monitor score for a particular monitor is generated by determining a total number of incident reports generated by the monitor during a past multi-service outage (nₘₒₙᵢₜₒᵣ_{ᵢ}) divided by the total number of incident reports generated by the same monitor (Frequencyₘₒₙᵢₜₒᵣ_{ᵢ}) during a longer predetermined time period in the past (referred to as a “lookback time range”). To factor in the change in frequency of incident report generation, Equation 1 is applied for multiple lookback time ranges (e.g., 300 days, 100 days, 50 days, etc.). The final monitor score is equal to the weighted sum of all of the lookback scores. In accordance with an embodiment, the weights (wⱼ) for each lookback time range is learned using logistic regression-based techniques.

In accordance with an embodiment, monitor filter 205 is configured to compare a monitor score of a monitor to a predetermined threshold. If the monitor score exceeds the predetermined threshold, monitor filter 205 determines that the associated monitor is highly correlated (i.e., has a relatively high level of correlation) with past multi-resource outages. If the monitor score does not exceed the predetermined threshold, monitor filter 205 determines that the associated monitor is not highly correlated (i.e., has a relatively low level of correlation) with past multi-resource outages. In accordance with another embodiment, monitor filter 205 ranks each of the determined monitor scores and determines that the monitors having the N highest monitor scores are highly correlated with past multi-resourced outages, where N is a specified positive integer.

Monitor filter 205 provides past incident reports 206 associated with monitors of monitors 208 having monitor scores indicative of a high correlation with respect to past multi-resource outages to metadata extractor 220. For instance, monitor filter 205 may provide a query to data store 202 specifying an identifier associated with each of monitors of monitors 208 having a monitor score exceeding the predetermined threshold. The query may further specify a time range for the past incident reports 206 to be provided (e.g., the last two years). Responsive to receiving the query, data store 202 provides the requested past incident reports 206 to monitor filter 205. Monitor filter 205 provides the received incident reports to metadata extractor 220. Monitor filter 205 also queries data store 202 to obtain incident reports generated by monitors having a monitor score indicative of a low (or no) correlation with respect to past multi-resource outages and provides such reports to metadata extractor 220. In accordance with an embodiment, monitor filter 205 may also obtain incident reports generated by relatively newer monitors introduced into system 200. Such monitors may be determined to have no (or a low) correlation to past outages due to the fact that they have not been generating incident reports for a relatively long period of time.

Metadata extractor 220 is configured to extract metadata from the incident reports associated with the monitors having a monitor score indicative of a high correlation, and the incident reports associated with the monitors having a monitor score indicative of a low correlation. Examples of such metadata include, but are not limited to, an identifier of the computing environment or location (e.g., a datacenter), an identifier of the monitor, an identifier of the device in which an alert was issued, a severity level of the alert, an identifier of the type of incident detected (e.g., a virtual machine-related incident, a storage-related incident, a network-related incident, a temperature-related incident, a power-related incident), a timestamp indicative of a time at which the events occurred, a number of resources affected by the event, etc.

Each of the metadata described above may be extracted from one or more fields of the incident reports that explicitly comprise such metadata. Certain metadata, such as the computing environment identifier, may not be explicitly identified. In such instances, metadata extractor 220 may be configured to infer the computing environment identifier based on metadata included in other fields of the incident reports that are known to include a computing environment identifier.

The computing environment identifier utilized in incident reports may be not be standardized. That is, certain monitors may use different naming conventions for the computing environment identifier. For example, a first incident report issued from a first monitor may indicate a first datacenter as “datacenter 1”, and a second incident report issued from a second monitor may indicate the first datacenter as “dc1.” Metadata extractor 220 is configured to standardize the different naming conventions into a single naming convention. For instance, metadata extractor 220 may maintain a mapping table that maps all the naming conventions utilized for a particular computing environment into a standardized identifier.

The extracted metadata is provided to featurizer 210. Featurizer 210 is configured to generate a feature vector for each incident report based on the extracted metadata. The feature vector is representative of the incident report. The feature vector generated by featurizer 210 may take any form, such as a numerical, visual and/or textual representation, or may comprise any other form suitable for representing an incident report. In an embodiment, a feature vector may include features such as keywords, a total number of words, and/or any other distinguishing aspects relating to an incident report that may be extracted therefrom. Featurizer 210 may operate in a number of ways to featurize, or generate a feature vector for, a given incident report. For example and without limitation, featurizer 210 may featurize an incident report through time series analysis, keyword featurization, semantic-based featurization, digit count featurization, and/or n-gram-TFIDF featurization.

Dataset builder 218 is configured to determine first feature vectors 242 associated with metadata extracted from the incident reports generated from monitors having a high correlation (e.g., generated during known past multi-resource outages) and determine second feature vectors 244 associated with extracted metadata from incident reports generated from monitors having a low correlation (e.g., generated when no multi-resource outage occurred). For instance, the incident reports issued during past multi-resource outages that are selected for first feature vectors 242 may be aggregated and selected based on certain metadata included therein that are indicative of a multi-resource outage (e.g., “power loss,” “network outage,”, etc.). The aggregated and selected incident reports may also have been issued at a time at which a known multi-resource outage occurred and where multiple resources were impacted. The aggregated and selected incident reports may also be associated with incidents having a particular severity level(s) (e.g., severity levels between 0 and 2). The feature vectors associated with such incident reports are provided to supervised machine learning algorithm 214 as first training data 236 (also referred to as positively-labeled data). Examples of features included in the feature vectors include, but are not limited to, an identifier of the computing environment (e.g., a datacenter), an identifier of the monitor, an identifier of the device in which an alert was issued, a severity level of the alert, an identifier of the type of incident detected (e.g., a virtual machine-related incident, a storage-related incident, a network-related incident, a temperature-related incident, a power-related incident), a timestamp indicative of a time at which the events occurred, a number of resources affected by the event, etc.

Second feature vectors 244 are associated with incident reports that were not issued during past multi-resource outages. For instance, such incident reports may not have any temporal proximity to any of the incident reports associated with first feature vectors 242 and were not issued during any known past multi-resource outage. Second feature vectors 244 are provided to supervised machine learning algorithm 214 as second training data 238 (also referred to as negatively-labeled data 238).

Supervised machine learning algorithm 214 is configured to receive first training data 236 as a first input and second training data 238 as a second input. Using these inputs, supervised machine learning algorithm 214 learns what constitutes a multi-resource service outage and generates a classification model 216 that is utilized to generate a score indicative of the likelihood that a multi-resource outage exists based on newly-generated incident reports (e.g., new incident reports 222). In accordance with an embodiment, supervised machine learning algorithm 214 is a gradient boosting-based algorithm.

It is noted that multi-resource outage detector 212 may be configured to receive incident reports from monitors located in different computing environments. In such instances, multi-resource outage detector 212 may be configured to group incident reports by computing environment or region (e.g., on a datacenter-by-datacenter basis) using the computing environment identifier included in incident reports 206.

In accordance with an embodiment, the performance of classification model 216 may be improved. For instance, after classification model 216 is generated, feature vectors generated for past incident reports 206 is provided to classification model 216, and the outputted scores indicative of a high likelihood that a multi-resource outage existed are verified to determine whether it is a true positive (i.e., classification model 216 correctly predicted that a multi-resource outage existed at a particular time) or a false positive (i.e., classification model 216 incorrectly predicted that a multi-resource outage existed at a particular time). The currently-labeled dataset (e.g., first training data 236 and second training data 238) is updated (or enriched) based on the determined true positives and/or false positives, and supervised machine learning algorithm 214 reperforms the learning process. The aforementioned may be performed multiple times in an iterative manner, and the performance of classification model 216 is improved at each iteration. That is, because after each iteration, classification model 214 will be retrained with its most ambiguous data from the previous iteration (i.e., the false positives). This causes classification model 214 to be more robust to the ambiguous data points.

As new incident reports 222 are generated by monitors 208, it is provided to metadata extractor 220, which extracts metadata from new incident reports 222 in a similar manner described above with respect to past incident reports 206. The extracted metadata is provided to featurizer 210, which generates a feature vector based on the extracted metadata in a similar manner as described above with reference to past incident reports 206. The feature vector (shown as feature vector 240) is provided to classification model 216. Other machine learning techniques, including, but not limited to, data normalization, feature selection and hyperparameter tuning may be applied to classification model 216 to improve the accuracy.

Classification model 216 outputs a score 246 indicative of a likelihood that a multi-resource outage exists with respect to the computing environment being monitored. Score 246 may comprise a value between 0.0 and 1.0, where higher the number, the greater the likelihood that a multi-resource outage exists. In accordance with an embodiment, a score being greater than a predetermined threshold (e.g., 0.5) may be indicative of a multi-resource outage. In accordance with such an embodiment, classification model 216 determines that a multi-resource outage exists if the score is greater than the predetermined threshold. It is noted that the score values described herein are purely exemplary and that other score values may be utilized.

As described above, it is noted that multi-resource outage detector 212 may be configured to receive incident reports from monitors located in different computing environments. In such instances, classification model 216 analyzes incident reports 222 on a per compute-environment or per-region basis.

A subset of the incident reports upon which such a determination is made may also be identified. For instance, contribution determiner 228 may determine a contribution score for each feature vector (corresponding to each incident report) provided to classification model 216. For instance, contribution determiner 228 may determine the relationship between a particular feature input into to classification model 216 and the score (e.g., score 246) outputted thereby for a particular node. For example, contribution determiner 228 may modify an input feature value and observe the resulting impact on output score 246. If output score 246 is not greatly affected, then contribution determiner 228 determines that the input feature does not impact output score 246 very much and assigns that input feature a relatively low contribution score. If the output score is greatly affected, then contribution determiner 228 determines that the input feature does impact output score 246 and assigns the input feature a relatively high contribution score. In accordance with an embodiment, contribution determiner 228 utilizes a local interpretable model-agnostic explanation (LIME)-based technique to generate the contribution scores. The incident reports associated with the feature vectors having the most impact are provided to root cause determiner 224.

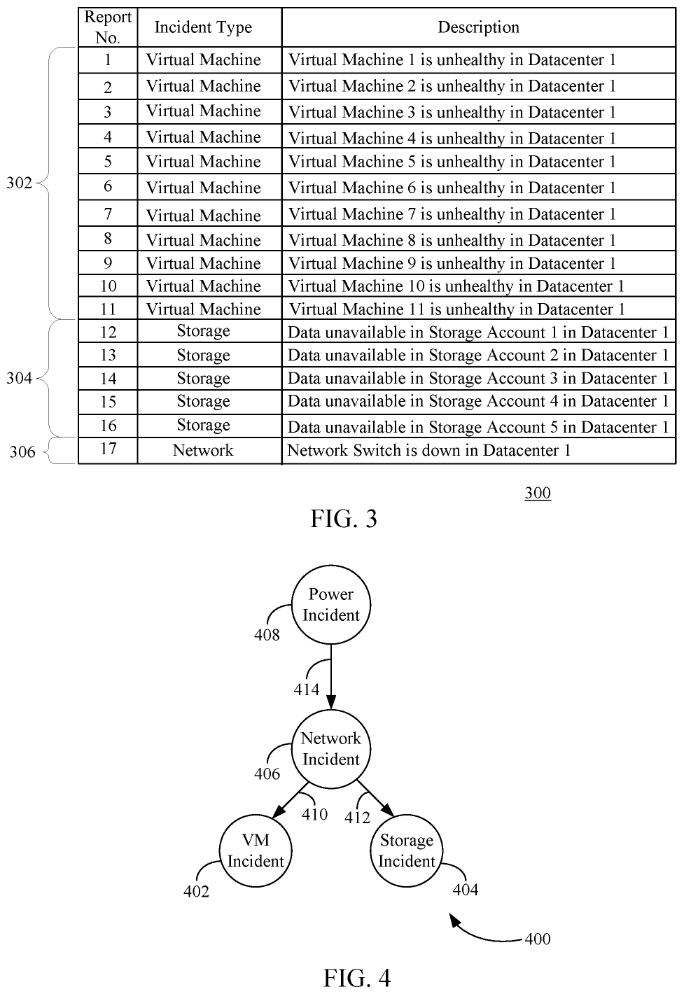

For example, FIG. 3 depicts a listing 300 of example incident reports identified by contribution determiner 220 as contributing to the multi-service outage detected by classification model 216 in accordance with an embodiment. In the example shown in FIG. 3, listing 300 comprises 17 example incident reports. Incident reports 302 are associated with a first incident type (e.g., a virtual machine incident) and indicates that eleven virtual machines (virtual machines 1-11) are unhealthy in “datacenter 1”. Incident reports 304 are associated with a second incident type (“storage incident”) and indicate that 5 storage accounts in “datacenter 1” are inaccessible. Incident report 306 is associated with a third incident type (“network incident”) and indicates that a network switch in “datacenter 1” is down. It is noted that listing 300 is simply a representation of incident reports that may be identified by contribution determiner 228 and that each of the incident reports included in listing 300 may comprise additional details, such as, but not limited to, a severity level of each incident, a timestamp indicative of a time at which each incident occurred, etc.

Root cause determiner 230 is configured determine a common root cause of the detected multi-resource outage based on analysis of the incident reports identified by contribution determiner 228 (e.g., the incident reports in listing 300). For example, root cause determiner 230 may determine the common root cause based on an analysis of the incident reports with respect to dependency graph 232. Dependency graph 232 may represent an order of dependencies between different incident types.

For example, FIG. 4 depicts an example dependency graph 400 in accordance with an embodiment. Dependency graph 400 is an example of dependency graph 232, as shown in FIG. 2. As shown in FIG. 4, dependency graph 400 comprises a first node 402, a second node 404, a third node 406, and a fourth node 408. First node 402 is coupled to third node 406 via a first edge 410. Second node 404 is coupled to third node 406 via a second edge 412. Third node 406 is coupled to fourth node 408 via a third edge 414. Each of nodes 402, 404, 406, and 408 represents a particular incident type. For instance, node 402 represents a virtual machine incident type, node 404 represents a storage incident type, node 406 represents a network incident type, and node 408 represents a power incident type. Each of edges 410, 412, and 414 represent a dependency between incident types represented by nodes coupled thereto. Accordingly, a virtual machine incident and a storage incident may depend on (i.e., may be the result of) a network incident, and a network incident may depend on (i.e., may be the result of) a power incident. For example, an issue with a network switch may cause issues with both virtual machines and storage devices and/or accounts in the monitored system. Similarly, an issue with the network switch may be caused due a power-related incident, as represented by node 408. It is noted that dependency graph 400 may comprise any number of nodes representing any number of incident types and any number of edges and that the nodes, edges, and numbers thereof depicted via dependency graph 400 are purely exemplary.

When analyzing dependency graph 400, root cause determiner 230 identifies each node of dependency graph 400 that corresponds to the incident reports identified by classification model 216 (e.g., incident reports 302, 304, and 306). For instance, in the examples shown in FIGS. 3 and 4, root cause determiner 230 may map incident reports 302 to node 402, may map incident reports 304 to node 404, and map incident report 306 to node 406. After incident reports 302, 304, and 306 are mapped to the nodes of dependency graph 400, root cause determiner 230 traverses dependency graph 300 to identify a parent node that is common to each of the identified nodes in the dependency graph. For instance, root cause determiner 230 may start at the children nodes (e.g., nodes 402 and 404) and determine whether incident reports are mapped thereto. If so, root cause determiner 230 traverses to the next level of dependency graph 230 (e.g., traverses upwards) to identify a parent node of such children nodes. Root cause determiner 230 may determine whether an incident report is mapped to such a node. In the example shown in FIG. 3, root cause determiner 230 determines that incident report 304 is mapped to node 406. As such, root cause determiner 230 identifies parent node 406 as being common to each of identified nodes 302 and 304.

Root cause determiner 230 continues to traverse dependency graph 232 until a determination is made that no other incident reports are mapped to nodes of dependency graph 232. After such a determination is made, root cause determiner 230 may determine whether dependency graph 232 comprises any additional parent nodes from which the identified parent node depends (e.g., node 408). If such additional parent nodes exist, root cause determiner 230 may determine that the incident type(s) associated with such node(s) are potential root cause(s) of the multi-service outage. Such a determination may be made with a relatively lower confidence, as root cause determiner 230 may not definitely determine whether such incident type(s) are root cause(s). As more incident reports are generated over time, root cause determiner 230 may revise its prediction (with increased confidence) based on how such incident reports map to dependency graph 232. Root cause determiner 230 may further perform additional diagnostics to determine whether incident types corresponding to such nodes is the root cause of the multi-service outage. For instance, in the example shown in FIG. 4, parent node 408 corresponds to a power-related incident type. Even though no incident reports of incident reports 302, 304, and 306 were mapped thereto, root cause determiner 230 determines whether an underlying power-related issue is the root cause of the multi-resource outage. For instance, root cause determiner 230 may query one or more of monitors 208 that are configured to monitor the power to computing devices on which the virtual machines and/or storage devices identified by incident reports 302 and 304 are executed and/or maintained. If such monitor(s) provide a response indicating that such computing devices are healthy (e.g., have adequate power levels), then root cause determiner 230 determines that there is no power-related issue associated with the multi-resource outage and identifies the incident type corresponding to node 406 (i.e., the parent node to which incident reports were mapped) as being the common root cause of the multi-resource outage. If such monitor(s) provide a response indicating that such computing devices are unhealthy (e.g., have inadequate power levels or are powered down), root cause determiner 230 determines that a power-related issue is responsible for the multi-resource outage and identifies the incident type corresponding to node 408 as being the common root cause.

After determining the common root cause, root cause determiner 230 provides a notification to action determiner 234. Action recommender 234 is configured to provide a multi-resource outage report, e.g., via incident resolver UI 118, as shown in FIG. 1. The multi-resource outage report may identify the determined multi-resource outage (as determined by root case determiner 230), provide each of the incident reports utilized by classification model 216 to make that determination (e.g., incident reports 302, 304, and 306), and/or a recommended action to take to mitigate the multi-resource outage. Action recommender 232 may further automatically perform a mitigating action and specify the action that was taken in the multi-resource outage report. Examples of mitigating actions include, but are not limited to, causing a computing device on which the problematic resources are executed and/or maintained to be restarted or suspended, causing a fan speed of such a computing device to be adjusted (e.g., increased if its temperate is too high, decreased if its temperate is too low), etc.

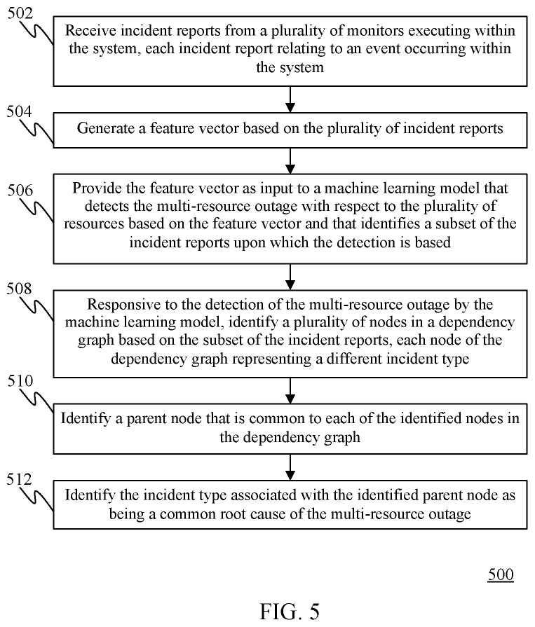

Accordingly, a common root cause for a multi-resource outage may be identified in many ways. For example, FIG. 5 shows a flowchart 500 of a computer-implemented method for detecting and remediating a multi-resource outage with respect to a plurality of resources implemented on a system of networked computing devices in accordance with example embodiment. In an embodiment, flowchart 500 may be implemented by system 200, as described in FIG. 2. Accordingly, flowchart 500 will be described with continued reference FIG. 2. Other structural and operational embodiments will be apparent to persons skilled in the relevant art(s) based on the following discussion regarding flowchart 500 and system 200.

In accordance with one or more embodiments, the system of networked computing devices comprises a first group of networked computing devices located in a first geographical region, and wherein the plurality of monitors from which the incident reports are received are located in the first geographical region.

As shown in FIG. 5, the method of flowchart 500 begins at step 502. At step 502, incident reports are received from a plurality of monitors executing within the system, each incident report relating to an event occurring within the system. For example, with reference to FIG. 2, metadata extractor 220 of multi-resource outage detector 212 receives incident reports (e.g., new incident reports 222) that were generated by monitors 208. Each of new incident reports 222 relates to an event occurring within the system. New incident reports 222 are received from data store 202.

At step 504, a feature vector is generated based on the plurality of incident reports. For example, with reference to FIG. 2, featurizer 210 generates feature vectors 240 based on metadata extracted from metadata extractor 220.

In accordance with one or more embodiments, the feature vector comprises one or more features comprising at least one of: a severity level for events occurring in the system; a timestamp indicative of a time at which each of the events occurred in the system; or a number of resources of the plurality of resources affected by the events.

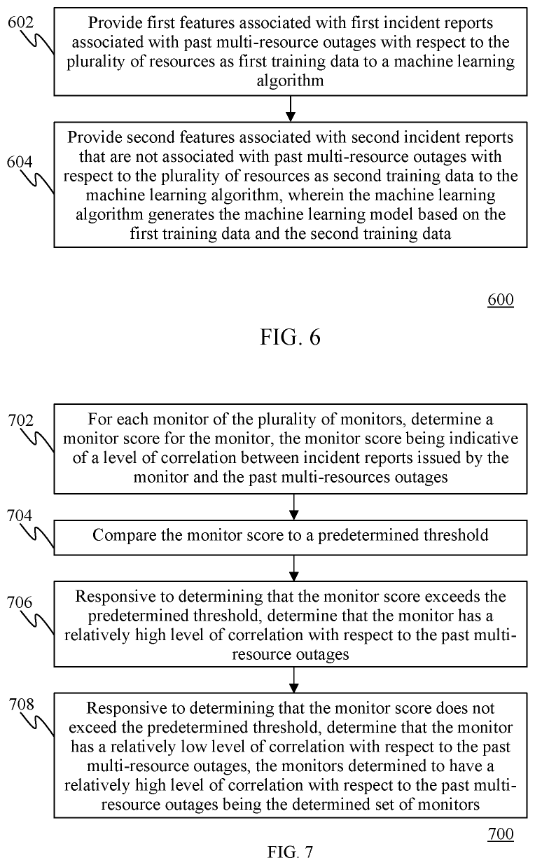

At step 506, the feature vector is provided as an input to a machine learning model that detects the multi-resource outage with respect to the plurality of resources based on the feature vector and that identifies a subset of the incident reports upon which the detection is based. For example, with reference to FIG. 2, feature vectors 240 are provided as an input to a machine learning model (i.e., classification model 216) that detects the multi-resource outage with respect to the plurality of resources based on feature vectors 240 and that identifies a subset of new incident reports 222 upon which the detection is based. The subset of new incident reports 222 may be identified by contribution determiner 228. Additional details regarding the generation of the machine learning model is provided below with reference to FIG. 6.

At step 508, responsive to the detection of the multi-resource outage by the machine learning model, a plurality of nodes in a dependency graph are identified based on the subset of the incident reports, each node of the dependency graph representing a different incident type. For example, with reference to FIG. 2, root cause determiner 230 identifies a plurality of nodes in dependency graph 232 based on the subset of new incident reports 222. As shown in FIG. 4, each of nodes 402, 404, 406, and 408 represent a particular incident type.

At step 510, a parent node that is common to each of the identified nodes is identified in the dependency graph. For example, with reference to FIG. 2, root cause determiner 230 identifies a parent node that is common to each of the identified nodes in dependency graph 232. For example, with reference to FIG. 4, root cause determiner 230 identifies parent node 406 as being common to each of the identified nodes.

At step 512, the incident type associated with the identified parent node is identified as being a common root cause of the multi-resource outage. For example, with reference to FIG. 2, root cause determiner 230 identifies the incident type associated with the identified parent node as being a common root cause of the multi-resource outage. With reference to FIG. 4, root cause determiner 230 identifies the incident type associated with node 406 as being the common root cause of the multi-resource outage.

In accordance with one or more embodiments, an action is performed to remediate the common root cause of the multi-resource outage. The action comprises at least one of causing a computing device of the networked computing devices associated with each resource of the plurality of resources impacted by the multi-resource outage to be restarted and providing a notification specifying at least one of the common root cause of the multi-resource outage or a mitigating action to be performed to mitigate the multi-resource outage. For example, with reference to FIG. 2, action determiner 234 is configured to perform an action to remediate the common root cause of the multi-resource outage. Action determiner 234 may cause a computing device of the networked computing devices associated with each resource of the plurality of resources impacted by the multi-resource outage to be restarted. For instance, action determiner 234 may provide a command to such devices that causes such devices to be restarted. In another example, action determiner 234 may provide a notification (e.g., via incident resolver UI 118, as shown in FIG. 1) specifying at least one of the common root cause of the multi-resource outage or a mitigating action to be performed to mitigate the multi-resource outage.

FIG. 6 shows a flowchart 600 of a computer-implemented method for generating a machine learning model in accordance with example embodiment. In an embodiment, flowchart 600 may be implemented by system 200, as described in FIG. 2. Accordingly, flowchart 600 will be described with continued reference FIG. 2. Other structural and operational embodiments will be apparent to persons skilled in the relevant art(s) based on the following discussion regarding flowchart 600 and system 200.

As shown in FIG. 6, the method of flowchart 600 begins at step 602. At step 602, first features associated with first incident reports associated with past multi-resource outages with respect to the plurality of resources is provided as first training data to a machine learning algorithm. For example, with reference to FIG. 2, featurizer 210 receives metadata extracted from past incident reports 206 associated with past multi-resource outages by metadata extractor 220 and featurizes the metadata to generate first features (or feature vectors 242) based on the extracted metadata. Feature vectors 242 are provided to dataset builder 218, which determines first training data 236 based thereon.

At step 604, second features associated with second incident reports associated with past multi-resource outages with respect to the plurality of resources is provided as first training data to a machine learning algorithm. For example, with reference to FIG. 2, featurizer 210 receives metadata extracted from past incident reports 206 that are not associated with past multi-resource outages by metadata extractor 220 and featurizes the metadata to generate second features (or feature vectors 244) based on the extracted metadata. Feature vectors 244 are provided to dataset builder 218, which determines second training data 236 based thereon. First training data 236 and second training data 238 are provided to supervised machine learning algorithm 214, which generates classification model 216 based on first training data 236 and second training data 238.

In accordance with one or more embodiments, the first incident reports are generated by a determined set of monitors from the plurality of monitors. FIG. 7 shows a flowchart 600 of a computer-implemented method for determining a set of monitors from which first incident reports are to be utilized for providing features to a machine learning algorithm in accordance with example embodiment. In an embodiment, flowchart 700 may be implemented by system 200, as described in FIG. 2. Accordingly, flowchart 700 will be described with continued reference FIG. 2. Other structural and operational embodiments will be apparent to persons skilled in the relevant art(s) based on the following discussion regarding flowchart 700 and system 200.

As shown in FIG. 7, the method of flowchart 700 begins at step 702. At step 702, for each monitor of the plurality of monitors, a monitor score for the monitor is determined, the monitor score being indicative of a level of correlation between incident reports issued by the monitor and the past multi-resources outages. For example, with reference to FIG. 2, monitor filter 205 generates a monitor score for each of monitors 208. The monitor score is indicative of a level of correlation between incident reports of past incident reports 206 issued by monitors 208 and the past multi-resources outages.

At step 704, the monitor score is compared to a predetermined threshold. For example, with reference to FIG. 2, monitor filter 205 compares the monitor score to a predetermined threshold.

At step 706, responsive to determining that the monitor score exceeds the predetermined threshold, a determination is made that the monitor has a relatively high level of correlation with respect to the past multi-resource outages. For example, with reference to FIG. 2, responsive to determining that the monitor score for a particular monitor of monitors 208 exceeds the predetermined threshold, monitor filter 205 determines that the monitor has a relatively high level of correlation with respect to the past multi-resource outages.

At step 708, responsive to determining that the monitor score does not exceed the predetermined threshold, a determination is made that the monitor has a relatively low level of correlation with respect to the past multi-resource outages. For example, with reference to FIG. 2, responsive to determining that the monitor score for a particular monitor of monitors 208 does not exceed the predetermined threshold, monitor filter 205 determines that the monitor has a relatively low level of correlation with respect to the past multi-resources outages. Monitor filter 205 determines that the monitors of monitors 208 having a relatively high level of correlation with respect to the past multi-resource outages are the determined set.

In accordance with one or more embodiments, the monitor score for a particular monitor of the plurality of monitors is determined based on a first number of incident reports issued by the particular monitor during the past multi-resource outages and a second number of incident reports issued by the particular monitor during a predetermined past period of time. For example, with reference to FIG. 2, monitor filter 205 determines the monitor score for a particular monitor of the monitor 208 based on a first number of incident reports of past incident reports 206 issued by the particular monitor during the past multi-resource outages and a second number of incident reports of past incident reports 206 issued by the particular monitor during a predetermined past period of time, as described above with reference to Equation 1.

In accordance with one or more embodiments, the monitor score for the particular monitor of the plurality of monitors is further determined based on a change of frequency at which the particular monitor issues incident reports. For example, with reference to FIG. 2, monitor filter 205 determines the monitor score for the particular monitor of monitors 208 based on a change of frequency at which the particular monitor issues past incident reports 206, as described above with reference to FIG. 1.

### III. Example Mobile and Stationary Device Embodiments

The systems and methods described above, including the root cause determination for multi-resource outage embodiments described in reference to FIGS. 1-7, may be implemented in hardware, or hardware combined with one or both of software and/or firmware. For example, monitored resource 102, monitoring system 104, monitors 108, multi-resource outage detector 112, computing device 114, configuration UI 116, incident resolver UI 118, multi-resource outage detector 212, monitor filter 205, metadata extractor 220, featurizer 220, dataset builder 218, supervised machine learning algorithm 214, classification model 216, contribution determiner 228, root cause determiner 230, action determiner 230, action determiner 234, data store 202, monitoring system 204, and monitor 208, and/or each of the components described therein, and flowchart 500, 600, and/or 700 may be each implemented as computer program code/instructions configured to be executed in one or more processors and stored in a computer readable storage medium. Alternatively, monitored resource 102, monitoring system 104, monitors 108, multi-resource outage detector 112, computing device 114, configuration UI 116, incident resolver UI 118, multi-resource outage detector 212, monitor filter 205, metadata extractor 220, featurizer 220, dataset builder 218, supervised machine learning algorithm 214, classification model 216, contribution determiner 228, root cause determiner 230, action determiner 230, action determiner 234, data store 202, monitoring system 204, and monitor 208, and/or each of the components described therein, and flowchart 500, 600, and/or 700 may be implemented as hardware logic/electrical circuitry. In an embodiment, monitored resource 102, monitoring system 104, monitors 108, multi-resource outage detector 112, computing device 114, configuration UI 116, incident resolver UI 118, multi-resource outage detector 212, monitor filter 205, metadata extractor 220, featurizer 220, dataset builder 218, supervised machine learning algorithm 214, classification model 216, contribution determiner 228, root cause determiner 230, action determiner 230, action determiner 234, data store 202, monitoring system 204, and monitor 208, and/or each of the components described therein, and flowchart 500, 600, and/or 700 may be implemented in one or more SoCs (system on chip). An SoC may include an integrated circuit chip that includes one or more of a processor (e.g., a central processing unit (CPU), microcontroller, microprocessor, digital signal processor (DSP), etc.), memory, one or more communication interfaces, and/or further circuits, and may optionally execute received program code and/or include embedded firmware to perform functions.

FIG. 8 depicts an exemplary implementation of a computing device 800 in which embodiments may be implemented, monitored resource 102, monitoring system 104, monitors 108, multi-resource outage detector 112, computing device 114, configuration UI 116, incident resolver UI 118, multi-resource outage detector 212, monitor filter 205, metadata extractor 220, featurizer 220, dataset builder 218, supervised machine learning algorithm 214, classification model 216, contribution determiner 228, root cause determiner 230, action determiner 230, action determiner 234, data store 202, monitoring system 204, and monitor 208, and/or each of the components described therein, and flowchart 500, 600, and/or 700. The description of computing device 800 provided herein is provided for purposes of illustration, and is not intended to be limiting. Embodiments may be implemented in further types of computer systems, as would be known to persons skilled in the relevant art(s).

As shown in FIG. 8, computing device 800 includes one or more processors, referred to as processor circuit 802, a system memory 804, and a bus 806 that couples various system components including system memory 804 to processor circuit 802. Processor circuit 802 is an electrical and/or optical circuit implemented in one or more physical hardware electrical circuit device elements and/or integrated circuit devices (semiconductor material chips or dies) as a central processing unit (CPU), a microcontroller, a microprocessor, and/or other physical hardware processor circuit. Processor circuit 802 may execute program code stored in a computer readable medium, such as program code of operating system 830, application programs 832, other programs 834, etc. Bus 806 represents one or more of any of several types of bus structures, including a memory bus or memory controller, a peripheral bus, an accelerated graphics port, and a processor or local bus using any of a variety of bus architectures. System memory 804 includes read only memory (ROM) 808 and random access memory (RAM) 810. A basic input/output system 812 (BIOS) is stored in ROM 808.

Computing device 800 also has one or more of the following drives: a hard disk drive 814 for reading from and writing to a hard disk, a magnetic disk drive 816 for reading from or writing to a removable magnetic disk 818, and an optical disk drive 820 for reading from or writing to a removable optical disk 822 such as a CD ROM, DVD ROM, or other optical media. Hard disk drive 814, magnetic disk drive 816, and optical disk drive 820 are connected to bus 806 by a hard disk drive interface 824, a magnetic disk drive interface 826, and an optical drive interface 828, respectively. The drives and their associated computer-readable media provide nonvolatile storage of computer-readable instructions, data structures, program modules and other data for the computer. Although a hard disk, a removable magnetic disk and a removable optical disk are described, other types of hardware-based computer-readable storage media can be used to store data, such as flash memory cards, digital video disks, RAMs, ROMs, and other hardware storage media.

A number of program modules may be stored on the hard disk, magnetic disk, optical disk, ROM, or RAM. These programs include operating system 830, one or more application programs 832, other programs 834, and program data 836. Application programs 832 or other programs 834 may include, for example, computer program logic (e.g., computer program code or instructions) for implementing the systems described above, including the root cause determination for multi-resource outage embodiments described in reference to FIGS. 1-7.

A user may enter commands and information into the computing device 800 through input devices such as keyboard 838 and pointing device 840. Other input devices (not shown) may include a microphone, joystick, game pad, satellite dish, scanner, a touch screen and/or touch pad, a voice recognition system to receive voice input, a gesture recognition system to receive gesture input, or the like. These and other input devices are often connected to processor circuit 802 through a serial port interface 842 that is coupled to bus 806, but may be connected by other interfaces, such as a parallel port, game port, or a universal serial bus (USB).

A display screen 844 is also connected to bus 806 via an interface, such as a video adapter 846. Display screen 844 may be external to, or incorporated in computing device 800. Display screen 844 may display information, as well as being a user interface for receiving user commands and/or other information (e.g., by touch, finger gestures, virtual keyboard, etc.). In addition to display screen 844, computing device 800 may include other peripheral output devices (not shown) such as speakers and printers.

Computing device 800 is connected to a network 848 (e.g., the Internet) through an adaptor or network interface 850, a modem 852, or other means for establishing communications over the network. Modem 852, which may be internal or external, may be connected to bus 806 via serial port interface 842, as shown in FIG. 8, or may be connected to bus 806 using another interface type, including a parallel interface.

As used herein, the terms “computer program medium,” “computer-readable medium,” and “computer-readable storage medium” are used to generally refer to physical hardware media such as the hard disk associated with hard disk drive 814, removable magnetic disk 818, removable optical disk 822, other physical hardware media such as RAMs, ROMs, flash memory cards, digital video disks, zip disks, MEMs, nanotechnology-based storage devices, and further types of physical/tangible hardware storage media (including system memory 804 of FIG. 8). Such computer-readable storage media are distinguished from and non-overlapping with communication media (do not include communication media). Communication media typically embodies computer-readable instructions, data structures, program modules or other data in a modulated data signal such as a carrier wave. The term “modulated data signal” means a signal that has one or more of its characteristics set or changed in such a manner as to encode information in the signal. By way of example, and not limitation, communication media includes wireless media such as acoustic, RF, infrared and other wireless media, as well as wired media. Embodiments are also directed to such communication media.

As noted above, computer programs and modules (including application programs 832 and other programs 834) may be stored on the hard disk, magnetic disk, optical disk, ROM, RAM, or other hardware storage medium. Such computer programs may also be received via network interface 850, serial port interface 852, or any other interface type. Such computer programs, when executed or loaded by an application, enable computing device 800 to implement features of embodiments discussed herein. Accordingly, such computer programs represent controllers of the computing device 800.

Embodiments are also directed to computer program products comprising computer code or instructions stored on any computer-readable medium. Such computer program products include hard disk drives, optical disk drives, memory device packages, portable memory sticks, memory cards, and other types of physical storage hardware.

### IV. Further Example Embodiments

A computer-implemented method for detecting and remediating a multi-resource outage with respect to a plurality of resources implemented on a system of networked computing devices. The method comprises: receiving incident reports from a plurality of monitors executing within the system, each incident report relating to an event occurring within the system; generating a feature vector based on the plurality of incident reports; providing the feature vector as input to a machine learning model that detects the multi-resource outage with respect to the plurality of resources based on the feature vector and that identifies a subset of the incident reports upon which the detection is based; and responsive to the detection of the multi-resource outage by the machine learning model: identifying a plurality of nodes in a dependency graph based on the subset of the incident reports, each node of the dependency graph representing a different incident type; identifying a parent node that is common to each of the identified nodes in the dependency graph; and identifying the incident type associated with the identified parent node as being a common root cause of the multi-resource outage.

In an embodiment of the foregoing computer-implemented method, the machine learning model is generated by: providing first features associated with first incident reports associated with past multi-resource outages with respect to the plurality of resources as first training data to a machine learning algorithm; providing second features associated with second incident reports that are not associated with past multi-resource outages with respect to the plurality of resources as second training data to the machine learning algorithm, wherein the machine learning algorithm generates the machine learning model based on the first training data and the second training data.

In an embodiment of the foregoing computer-implemented method, the first incident reports are generated by a determined set of monitors from the plurality of monitors, wherein the set of monitors are determined by: for each monitor of the plurality of monitors: determining a monitor score for the monitor, the monitor score being indicative of a level of correlation between incident reports issued by the monitor and the past multi-resources outages; comparing the monitor score to a predetermined threshold; responsive to determining that the monitor score exceeds the predetermined threshold, determining that the monitor has a relatively high level of correlation with respect to the past multi-resource outages; and responsive to determining that the monitor score does not exceed the predetermined threshold, determining that the monitor has a relatively low level of correlation with respect to the past multi-resource outages, the monitors determined to have a relatively high level of correlation with respect to the past multi-resource outages being the determined set of monitors.

In an embodiment of the foregoing computer-implemented method, the monitor score for a particular monitor of the plurality of monitors is determined based on a first number of incident reports issued by the particular monitor during the past multi-resource outages and a second number of incident reports issued by the particular monitor during a predetermined past period of time.

In an embodiment of the foregoing computer-implemented method, the monitor score for the particular monitor of the plurality of monitors is further determined based on a change of frequency at which the particular monitor issues incident reports.

In an embodiment of the foregoing computer-implemented method, the feature vector comprises one or more features comprising at least one of: a severity level for events occurring in the system; a timestamp indicative of a time at which each of the events occurred in the system; or a number of resources of the plurality of resources affected by the events.

In an embodiment of the foregoing computer-implemented method, the method further comprises: performing an action to remediate the common root cause of the multi-resource outage, wherein the action comprises at least one of: causing a computing device of the networked computing devices associated with each resource of the plurality of resources impacted by the multi-resource outage to be restarted; or providing a notification specifying at least one of the common root cause of the multi-resource outage or a mitigating action to be performed to mitigate the multi-resource outage.

In an embodiment of the foregoing computer-implemented method, wherein the system of networked computing devices comprises a first group of networked computing devices located in a first geographical region, and wherein the plurality of monitors from which the incident reports are received are located in the first geographical region.

A system for detecting and remediating a multi-resource outage with respect to a plurality of resources of a datacenter is also described herein. The system comprises: at least one processor circuit; and at least one memory that stores program code configured to be executed by the at least one processor circuit. The program code comprises: a multi-resource outage detector configured to: receive incident reports from a plurality of monitors executing within the datacenter, each incident report relating to an event occurring within the datacenter; generate a feature vector based on the plurality of incident reports; provide the feature vector as input to a machine learning model that detects the multi-resource outage with respect to the plurality of resources based on the feature vector and that identifies a subset of the incident reports upon which the detection is based; and responsive to the detection of the multi-resource outage by the machine learning model: identify a plurality of nodes in a dependency graph based on the subset of the incident reports, each node of the dependency graph representing a different incident type; identify a parent node that is common to each of the identified nodes in the dependency graph; and identify the incident type associated with the identified parent node as being a common root cause of the multi-resource outage.

In an embodiment of the foregoing system, the machine learning model is generated by: providing first features associated with first incident reports associated with past multi-resource outages with respect to the plurality of resources as first training data to a machine learning algorithm; providing second features associated with second incident reports that are not associated with past multi-resource outages with respect to the plurality of resources as second training data to the machine learning algorithm, wherein the machine learning algorithm generates the machine learning model based on the first training data and the second training data.

In an embodiment of the foregoing system, the first incident reports are generated by a determined set of monitors from the plurality of monitors, wherein the multi-resource outage detector comprises a monitor filter configured to: for each monitor of the plurality of monitors: determine a monitor score for the monitor, the monitor score being indicative of a level of correlation between incident reports issued by the monitor and the past multi-resources outages; compare the monitor score to a predetermined threshold; responsive to determining that the monitor score exceeds the predetermined threshold, determine that the monitor has a relatively high level of correlation with respect to the past multi-resource outages; and responsive to determining that the monitor score does not exceed the predetermined threshold, determine that the monitor has a relatively low level of correlation with respect to the past multi-resource outages, the monitors determined to have a relatively high level of correlation with respect to the past multi-resource outages being the determined set of monitors.

In an embodiment of the foregoing system, the monitor filter determines the monitor score for a particular monitor of the plurality of monitors based on a first number of incident reports issued by the particular monitor during the past multi-resource outages and a second number of incident reports issued by the particular monitor during a predetermined past period of time.

In an embodiment of the foregoing system, the monitor filter further determines the monitor score for the particular monitor of the plurality of monitors based on a change of frequency at which the particular monitor issues incident reports.

In an embodiment of the foregoing system, the feature vector comprises one or more features comprising at least one of: a severity level for events occurring in the datacenter; a timestamp indicative of a time at which each of the events occurred in the datacenter; or a number of resources of the plurality of resources affected by the events.

In an embodiment of the foregoing system, the multi-resource outage detector further comprises an action determiner configured to: perform an action to remediate the common root cause of the multi-resource outage, wherein the action comprises at least one of: cause a computing device of the networked computing devices associated with each resource of the plurality of resources impacted by the multi-resource outage to be restarted; or provide a notification specifying at least one of the common root cause of the multi-resource outage or a mitigating action to be performed to mitigate the multi-resource outage.

A computer-readable storage medium having program instructions recorded thereon that, when executed by at least one processor of a computing device perform a method for detecting and remediating a multi-resource outage with respect to a plurality of resources implemented on a system of networked computing devices is further described herein. The method comprises: receiving incident reports from a plurality of monitors executing within the system, each incident report relating to an event occurring within the system; generating a feature vector based on the plurality of incident reports; and providing the feature vector as input to a machine learning model that detects the multi-resource outage with respect to the plurality of resources based on the feature vector.

In an embodiment of the computer-readable storage medium, the machine learning model is generated by: providing first features associated with first incident reports associated with past multi-resource outages with respect to the plurality of resources as first training data to a machine learning algorithm; providing second features associated with second incident reports that are not associated with past multi-resource outages with respect to the plurality of resources as second training data to the machine learning algorithm, wherein the machine learning algorithm generates the machine learning model based on the first training data and the second training data.

In an embodiment of the computer-readable storage medium, the first incident reports are generated by a determined set of monitors from the plurality of monitors, wherein the set of monitors are determined by: for each monitor of the plurality of monitors: determining a monitor score for the monitor, the monitor score being indicative of a level of correlation between incident reports issued by the monitor and the past multi-resources outages; comparing the monitor score to a predetermined threshold; responsive to determining that the monitor score exceeds the predetermined threshold, determining that the monitor has a relatively high level of correlation with respect to the past multi-resource outages; and responsive to determining that the monitor score does not exceed the predetermined threshold, determining that the monitor has a relatively low level of correlation with respect to the past multi-resource outages, the monitors determined to have a relatively high level of correlation with respect to the past multi-resource outages being the determined set of monitors.

In an embodiment of the computer-readable storage medium, wherein the machine learning model further identifies a subset of the incident reports upon which the detection is based.

In an embodiment of the computer-readable storage medium, the method further comprises: responsive to the detection of the multi-resource outage by the machine learning model: identifying a plurality of nodes in a dependency graph based on the subset of the incident reports, each node of the dependency graph representing a different incident type; identifying a parent node that is common to each of the identified nodes in the dependency graph; and identifying the incident type associated with the identified parent node as being a common root cause of the multi-resource outage.

### V. Conclusion

While various embodiments have been described above, it should be understood that they have been presented by way of example only, and not limitation. It will be understood by those skilled in the relevant art(s) that various changes in form and details may be made therein without departing from the spirit and scope of the described embodiments as defined in the appended claims. Accordingly, the breadth and scope of the present embodiments should not be limited by any of the above-described exemplary embodiments, but should be defined only in accordance with the following claims and their equivalents.

What is claimed is:

1. A computer-implemented method for detecting and remediating a multi-resource outage with respect to a plurality of resources implemented on a system of networked computing devices, the method comprising:
receiving incident reports from a plurality of monitors executing within the system, each incident report relating to an event occurring within the system;
generating a feature vector based on the plurality of incident reports;
providing the feature vector as input to a machine learning model that detects the multi-resource outage with respect to the plurality of resources based on the feature vector and that identifies a subset of the incident reports upon which the detection is based; and
responsive to the detection of the multi-resource outage by the machine learning model:
identifying a plurality of nodes in a dependency graph based on the subset of the incident reports, each node of the dependency graph representing a different incident type;
identifying a parent node that is common to each of the identified nodes in the dependency graph; and
identifying the incident type associated with the identified parent node as being a common root cause of the multi-resource outage.

2. The computer-implemented method of claim 1, wherein the machine learning model is generated by:
providing first features associated with first incident reports associated with past multi-resource outages with respect to the plurality of resources as first training data to a machine learning algorithm; and
providing second features associated with second incident reports that are not associated with past multi-resource outages with respect to the plurality of resources as second training data to the machine learning algorithm,
wherein the machine learning algorithm generates the machine learning model based on the first training data and the second training data.

3. The computer-implemented method of claim 2, wherein the first incident reports are generated by a determined set of monitors from the plurality of monitors, wherein the set of monitors are determined by:
for each monitor of the plurality of monitors:
determining a monitor score for the monitor, the monitor score being indicative of a level of correlation between incident reports issued by the monitor and the past multi-resources outages;
comparing the monitor score to a predetermined threshold;
responsive to determining that the monitor score exceeds the predetermined threshold, determining that the monitor has a relatively high level of correlation with respect to the past multi-resource outages; and
responsive to determining that the monitor score does not exceed the predetermined threshold, determining that the monitor has a relatively low level of correlation with respect to the past multi-resource outages,
the monitors determined to have a relatively high level of correlation with respect to the past multi-resource outages being the determined set of monitors.

4. The computer-implemented method of claim 3, wherein the monitor score for a particular monitor of the plurality of monitors is determined based on a first number of incident reports issued by the particular monitor during the past multi-resource outages and a second number of incident reports issued by the particular monitor during a predetermined past period of time.

5. The computer-implemented method of claim 4, wherein the monitor score for the particular monitor of the plurality of monitors is further determined based on a change of frequency at which the particular monitor issues incident reports.

6. The computer-implemented method of claim 1, wherein the feature vector comprises one or more features comprising at least one of:
a severity level for events occurring in the system;
a timestamp indicative of a time at which each of the events occurred in the system; or
a number of resources of the plurality of resources affected by the events.

7. The computer-implemented method of claim 1, further comprising:
performing an action to remediate the common root cause of the multi-resource outage, wherein the action comprises at least one of:
causing a computing device of the networked computing devices associated with each resource of the plurality of resources impacted by the multi-resource outage to be restarted; or
providing a notification specifying at least one of the common root cause of the multi-resource outage or a mitigating action to be performed to mitigate the multi-resource outage.

8. The computer-implemented method of claim 1, wherein the system of networked computing devices comprises a first group of networked computing devices located in a first geographical region, and wherein the plurality of monitors from which the incident reports are received are located in the first geographical region.

9. A system for detecting and remediating a multi-resource outage with respect to a plurality of resources of a datacenter, comprising:
at least one processor circuit; and
at least one memory that stores program code configured to be executed by the at least one processor circuit, the program code comprising:
a multi-resource outage detector configured to:
receive incident reports from a plurality of monitors executing within the datacenter, each incident report relating to an event occurring within the datacenter;
generate a feature vector based on the plurality of incident reports;
provide the feature vector as input to a machine learning model that detects the multi-resource outage with respect to the plurality of resources based on the feature vector and that identifies a subset of the incident reports upon which the detection is based; and
responsive to the detection of the multi-resource outage by the machine learning model:
identify a plurality of nodes in a dependency graph based on the subset of the incident reports, each node of the dependency graph representing a different incident type;
identify a parent node that is common to each of the identified nodes in the dependency graph; and
identify the incident type associated with the identified parent node as being a common root cause of the multi-resource outage.

10. The system of claim 9, wherein the machine learning model is generated by:
providing first features associated with first incident reports associated with past multi-resource outages with respect to the plurality of resources as first training data to a machine learning algorithm; and
providing second features associated with second incident reports that are not associated with past multi-resource outages with respect to the plurality of resources as second training data to the machine learning algorithm,
wherein the machine learning algorithm generates the machine learning model based on the first training data and the second training data.

11. The system of claim 10, wherein the first incident reports are generated by a determined set of monitors from the plurality of monitors, wherein the multi-resource outage detector comprises a monitor filter configured to:
for each monitor of the plurality of monitors:
determine a monitor score for the monitor, the monitor score being indicative of a level of correlation between incident reports issued by the monitor and the past multi-resources outages;
compare the monitor score to a predetermined threshold;
responsive to determining that the monitor score exceeds the predetermined threshold, determine that the monitor has a relatively high level of correlation with respect to the past multi-resource outages; and
responsive to determining that the monitor score does not exceed the predetermined threshold, determine that the monitor has a relatively low level of correlation with respect to the past multi-resource outages,
the monitors determined to have a relatively high level of correlation with respect to the past multi-resource outages being the determined set of monitors.

12. The system of claim 11, wherein the monitor filter determines the monitor score for a particular monitor of the plurality of monitors based on a first number of incident reports issued by the particular monitor during the past multi-resource outages and a second number of incident reports issued by the particular monitor during a predetermined past period of time.

13. The system of claim 12, wherein the monitor filter further determines the monitor score for the particular monitor of the plurality of monitors based on a change of frequency at which the particular monitor issues incident reports.

14. The system of claim 9, wherein the feature vector comprises one or more features comprising at least one of:
a severity level for events occurring in the datacenter;
a timestamp indicative of a time at which each of the events occurred in the datacenter; or
a number of resources of the plurality of resources affected by the events.

15. The system of claim 9, wherein the multi-resource outage detector further comprises an action determiner configured to:
perform an action to remediate the common root cause of the multi-resource outage, wherein the action comprises at least one of:
cause a computing device of the networked computing devices associated with each resource of the plurality of resources impacted by the multi-resource outage to be restarted; or
provide a notification specifying at least one of the common root cause of the multi-resource outage or a mitigating action to be performed to mitigate the multi-resource outage.

16. A computer-readable storage medium having program instructions recorded thereon that, when executed by at least one processor of a computing device perform a method for detecting and remediating a multi-resource outage with respect to a plurality of resources implemented on a system of networked computing devices, the method comprising:
receiving incident reports from a plurality of monitors executing within the system, each incident report relating to an event occurring within the system;
generating a feature vector based on the plurality of incident reports; and
providing the feature vector as input to a machine learning model that detects the multi-resource outage with respect to the plurality of resources based on the feature vector.

17. The computer-readable storage medium of claim 16, wherein the machine learning model is generated by:
providing first features associated with first incident reports associated with past multi-resource outages with respect to the plurality of resources as first training data to a machine learning algorithm; and
providing second features associated with second incident reports that are not associated with past multi-resource outages with respect to the plurality of resources as second training data to the machine learning algorithm,
wherein the machine learning algorithm generates the machine learning model based on the first training data and the second training data.

18. The computer-readable storage medium of claim 17, wherein the first incident reports are generated by a determined set of monitors from the plurality of monitors, wherein the set of monitors are determined by:
for each monitor of the plurality of monitors:
determining a monitor score for the monitor, the monitor score being indicative of a level of correlation between incident reports issued by the monitor and the past multi-resources outages;
comparing the monitor score to a predetermined threshold;
responsive to determining that the monitor score exceeds the predetermined threshold, determining that the monitor has a relatively high level of correlation with respect to the past multi-resource outages; and
responsive to determining that the monitor score does not exceed the predetermined threshold, determining that the monitor has a relatively low level of correlation with respect to the past multi-resource outages,
the monitors determined to have a relatively high level of correlation with respect to the past multi-resource outages being the determined set of monitors.

19. The computer-readable storage medium of claim 16, wherein the machine learning model further identifies a subset of the incident reports upon which the detection is based.

20. The computer-readable storage medium of claim 19, the method further comprising:
responsive to the detection of the multi-resource outage by the machine learning model:
identifying a plurality of nodes in a dependency graph based on the subset of the incident reports, each node of the dependency graph representing a different incident type;
identifying a parent node that is common to each of the identified nodes in the dependency graph; and
identifying the incident type associated with the identified parent node as being a common root cause of the multi-resource outage.
